(19) United States
(12) Patent Application Publication
(10) Pub. No.: US 2025/0260304 A1
(43) Pub. Date: Aug. 14, 2025

(54) Gate Driving Circuit for Wide Bandgap (WBG) Power Devices

(71) Applicant: Hong Kong Applied Science and Technology Research Institute Company Limited, Hong Kong (HK)

(72) Inventors: Nibedita PARIDA, Hong Kong (HK); Chun Kit CHEUNG, Hong Kong (HK)

(21) Appl. No.: 18/437,266

(22) Filed: Feb. 9, 2024

(51) Int. Cl. H02M 1/088; H02J 50/10; H02M 3/00; H02M 3/335

(52) U.S. Cl. CPC H02M 1/088; H02J 50/10; H02M 3/01; H02M 3/33573; H02M 3/33576

(57) ABSTRACT

A resonant-based gate driving circuit for WBG power semiconductor devices is provided to suppress crosstalk in one leg configured power converters. The gate driving circuit comprises DC voltage source, first and second semiconductor switches, and a crosstalk suppressing circuit including: a first resonant inductor and a first resistor configured to form a path for charging an input capacitance of the WBG device up to the DC voltage source when a logic high control signal is generated from controller output and applied to the gate terminal of first and second semiconductor switches; a diode, a second resonance inductor, and a second resistor configured to form a path for discharging the input capacitance of WBG device, and to provide an adjustable negative gate-source turn-off voltage to the WBG device when a logic low control signal is generated from controller output and applied to the gate terminal of first and second semiconductor switches.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to a methodology for gate driving approach of wide bandgap (WBG) power semiconductor devices. More specifically the present invention relates to a resonance-based circuit for suppressing crosstalk when driving a wide bandgap device.

### BACKGROUND OF THE INVENTION

Wide bandgap (WBG) power semiconductor devices, such as silicon carbide (SIC) power metal-oxide-semiconductor field-effect transistors (MOSFETs) and gallium nitride (GaN) field-effect transistors (FETs), are emerging solutions for high-efficiency and high-power-density power electronics and systems applications. As shown in FIG. 1, a half-bridge converter is composed of a one leg configuration including two WBG power switches such as SiC MOSFETs. When the SiC MOSFETs are operated at high switching frequency, during turn-on transition of the high side MOSFET, a high dv/dt at the low side MOSFET induces a charging current to its input capacitance, resulting in a sudden increase in gate source voltage of the low side MOSFET, causing a spurious pulse which exceeds the threshold voltage of the low side MOSFET. Therefore, false turn-on occurs and both power MOSFETs are turned on accidentally. Such a phenomenon is called crosstalk. The crosstalk issue may cause shoot-through resulting in high short-circuit current which may lead to the damage of WBG power semiconductor devices or even explosion. Moreover, oscillations in voltage and current may cause severe electromagnetic interference (EMI) problems and will degrade converter's reliability and efficiency.

### SUMMARY OF THE INVENTION

It is one objective of the present invention to provide a gate driving circuit which can suppress crosstalk in one leg configured power converters, such as half bridge, full-bridge, or synchronous buck converters and suitable for diving WBG power semiconductor devices in. It is another objective of the present invention to provide a resonant-based gate driving circuit with simpler configuration and less power consumption when compared to conventional solutions.

In accordance with a first aspect of the present invention, a gate driving circuit for driving a wide bandgap power device is provided. The gate driving circuit comprises: a DC voltage source, a first semiconductor switching device having a high voltage terminal connected to a positive terminal of the DC voltage source and a control terminal connected to a controller output; a second semiconductor switching device having a low voltage terminal connected to a negative terminal of the DC voltage source and a control terminal connected to a controller output; and a crosstalk suppressing circuit. The crosstalk suppressing circuit includes a first resonant inductor having a first end connected to a low voltage terminal of the first semiconductor switching device; a first resistor having a first end connected to a second end of the first resonant inductor and a second end connected to a gate terminal of the WBG power semiconductor device; a first diode having an anode terminal connected to the gate of the WBG power semiconductor device and a cathode terminal connected to a positive terminal of the DC voltage source; a second diode having a cathode connected to a high voltage terminal of the second semiconductor switching device; a second resonant inductor having a first end connected to an anode of the second diode; a second resistor having a first end connected to a second end of the second resonant inductor and a second end connected to the gate of the WBG power semiconductor device. The first resonant inductor and the first resistor are configured to form a path for charging an input capacitance of the WBG power semiconductor device up to the DC voltage source when a logic high control signal is generated from the controller output and applied to the gate terminal of first and second semiconductor switches. The first diode is configured to clamp a gate-to-source voltage of the WBG power semiconductor device to the DC voltage source to serve as a protection; and the second diode, the second resonant inductor, and the second resistor are configured to form a path for discharging the input capacitance of WBG power semiconductor device, and to provide an adjustable negative gate-source turn-off voltage to the WBG power semiconductor device when a logic low control signal is generated from the controller output and applied to the gate terminal of first and second semiconductor switches.

In accordance with a second aspect of the present invention, a CLLC resonant converter-based battery energy storage system is provided. The CLLC resonant converter-based battery energy storage system comprises one or more gate driving circuits according to the first aspect of the present invention.

In accordance with a third aspect of the present invention, a wireless power transfer system having an AC/DC hard-switched converter and a DC/DC hard-switched converter is provided. Each of the AC/DC hard-switched converter and DC/DC hard-switched converter comprises one or more gate driving circuits according to the first aspect of the present invention.

### BRIEF DESCRIPTION OF THE DRAWINGS:

Embodiments of the invention are described in more details hereinafter with reference to the drawings, in which:

FIG. 1 shows a half bridge converter having a one leg configuration including two WBG power semiconductor switches, Q1 and Q2.

FIG. 2 shows a circuit diagram of a gate driving circuit for driving a WBG power semiconductor device Q1 in accordance with one embodiment of the present invention.

FIGS. 3A and 3B show equivalent circuits of the gate driving circuit during the turn-on transition period (denoted as tᵣₒₙ) and the turn-off transition period (denoted as t_{roff}). respectively.

FIG. 4 shows waveforms of the control signal G, switching states of switches SW1 and SW2, the gate-source voltage V_{gs} of the WBG power semiconductor device Q1, and the gate current i_{g}.

FIG. 5 shows the flow chart of key design steps required for the gate driving circuit.

FIG. 6 shows experimental results of turn-on transition period tᵣₒₙ and the turn-off transition period t_{roff} achieved with the gate driving circuit according to the present invention.

FIG. 7 shows experimental results of V_{gs} of two WBG power semiconductor devices Q1, Q2 in a half bridge converter for illustration of crosstalk suppression.

FIG. 8 shows a circuit diagram of a gate driving circuit according to another embodiment of the present invention.

FIG. 9 shows a circuit diagram of a gate driving circuit according to another embodiment of the present invention.

FIG. 10 shows a circuit diagram of a gate driving circuit according to another embodiment of the present invention.

FIG. 11 shows a circuit diagram of a gate driving circuit according to another embodiment of the present invention.

FIG. 12 shows a circuit diagram of a gate driving circuit according to another embodiment of the present invention.

FIG. 13 shows a circuit diagram of a gate driving circuit according to another embodiment of the present invention.

FIG. 14 shows a circuit diagram of a CLLC resonant converter-based battery energy storage system constructed with the gate driving circuits (denoted as Dr1-Dr8) according to the embodiments of the present invention.

FIG. 15 shows a circuit diagram of a wireless power transfer system having an AC/DC and a DC/DC hard-switched based converters constructed with the gate driving circuits (denoted as Dr1-Dr8) according to the embodiments of the present invention.

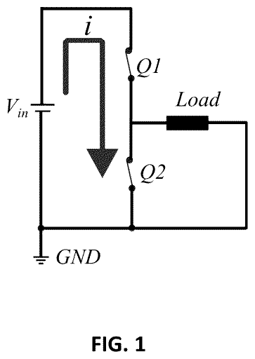

### DETAILED DESCRIPTION

In the following description, details of the present invention are set forth as preferred embodiments. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

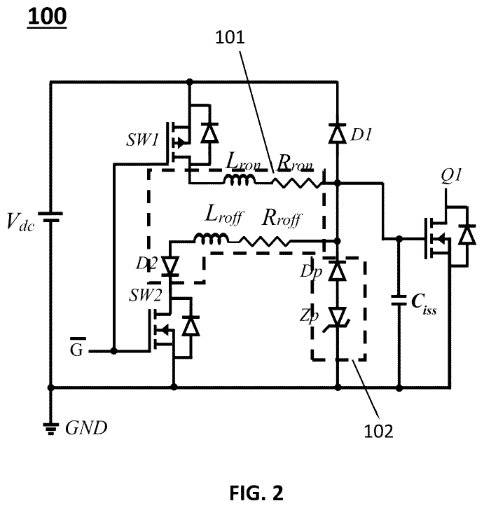

FIG. 2 shows a circuit diagram of a gate driving circuit 100 for driving a WBG power semiconductor device Q1 in accordance with one embodiment of the present invention.

As shown, the gate driving circuit 100 comprises a DC voltage source V_{dc}; a first semiconductor switching device SW1 having a high voltage terminal connected to a positive terminal of the DC voltage source V_{dc} and a control terminal connected to a controller output G̅; and a second semiconductor switching device SW2 having a low voltage terminal connected to a negative terminal of the DC voltage source and a control terminal connected to the controller output G̅.

The gate driving circuit 100 may further comprise a crosstalk suppressing circuit 101 including: a resonant inductor Lᵣₒₙ having a first end connected to a low voltage terminal of the first semiconductor switching device SW1; a resistor Rᵣₒₙ having a first end connected to a second end of the resonant inductor Lᵣₒₙ and a second end connected to the gate terminal of the WBG power semiconductor device Q1; a diode D2 having a cathode connected to a high voltage terminal of the second semiconductor switching device SW2; a resonant inductor L_{roff} having a first end connected to an anode of the diode D2; a resistor R_{roff} having a first end connected to a second end of the resonant inductor L_{roff} and a second end connected to the gate terminal of the WBG power semiconductor device Q1.

The resonant inductor Lᵣₒₙ and the resistor Rᵣₒₙ are configured to form a path for charging an input capacitance Cᵢₛₛ of the the WBG power semiconductor device Q1 up to the DC voltage source V_{dc} when a logic high control signal is generated from the controller output. The diode D2 is configured to form a path for discharging the input capacitance Cᵢₛₛ of WBG power semiconductor device Q1. The resonant inductor L_{roff} and the resistor R_{roff} are configured to provide an adjustable negative gate-source turnoff voltage −Vₑ to the WBG power semiconductor device Q1 to suppress crosstalk in various applications, such as bridge converters, when a logic low control signal is generated from controller output.

The gate driving circuit 100 may further comprise a protection circuit 102 across the gate and source of the WBG power semiconductor device Q1. The protection circuit 102 may include a Zener diode Zp and a diode Dp connected back-to-back with the Zener diode Zp. That is, the diode Dp has a cathode connected to the gate terminal of the WBG power semiconductor device Q1; the Zener diode Zp has an anode connected to an anode of the diode Dp and a cathode connected to the source terminal of the WBG power semiconductor device Q1.

The gate driving circuit 100 further comprises a clamping diode D1 configured for clamping a gate source voltage V_{gs} of the WBG power semiconductor device power device Q1 to the supply voltage of the DC voltage source V_{dc}, that is, to prevent the gate source voltage V_{gs} applied on the WBG power semiconductor device Q1 from exceeding the voltage V_{dc}. The clamping diode D1 has an anode connected to a gate terminal of the WBG power semiconductor device Q1 and a cathode connected to the positive terminal of the voltage source V_{dc}.

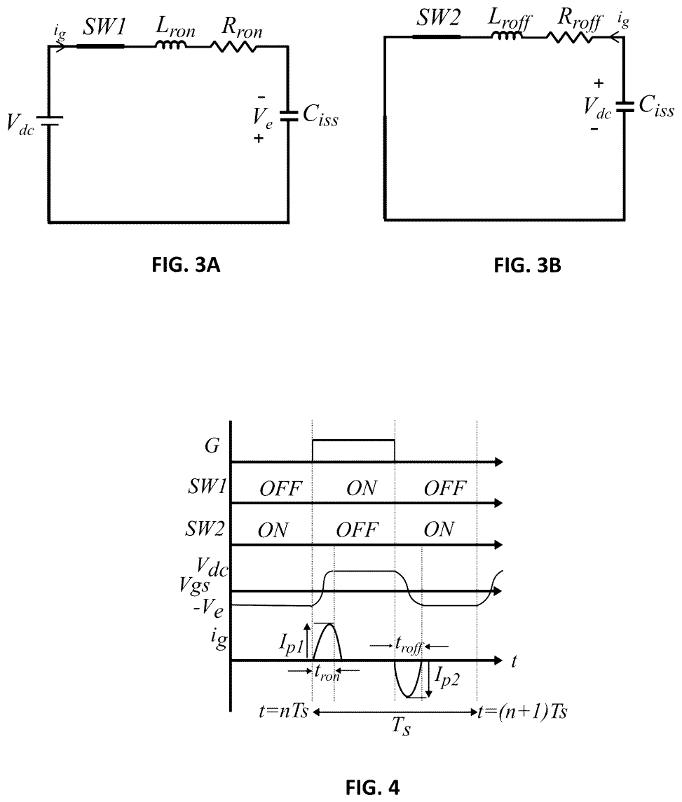

FIGS. 3A and 3B show equivalent circuits of the gate driving circuit 100 during the turn-on transition period (denoted as tᵣₒₙ) and the turn-off transition period (denoted as t_{roff}), respectively.

The resonant frequency of the crosstalk suppressing circuit during tᵣₒₙ is given by:

$${ω}_{r 1} = \frac{1}{\sqrt{{L}_{ron} {C}_{iss}}} \qquad ( 1 a )$$

The resonant frequency of the crosstalk suppressing circuit during t_{roff} is given by:

$${ω}_{r 2} = \frac{1}{\sqrt{{L}_{roff} {C}_{iss}}} \qquad ( 1 b )$$

The gate current is given by:

$${i}_{g} ( t ) = \frac{{V}_{d c} + {V}_{e}}{{ω}_{d 1} {L}_{ron}} {e}^{- α 1 t} sin ( {ω}_{d 1} t ) \qquad ( 2 )$$

The gate-source voltage V_{gs} of Q1 during tᵣₒₙ is given by:

$${v}_{gs 1} ( t ) = ( {V}_{d c} + {V}_{e} ) ( 1 - {e}^{- α 1 t} cos ( {ω}_{d 1} t ) - \frac{α 1}{{ω}_{d 1}} {e}^{- α 1 t} sin ( {ω}_{d 1} t ) ) - {V}_{e} \qquad ( 3 )$$

The gate-source voltage V_{gs} of Q1 during t_{roff} is given by:

$${v}_{gs 2} ( t ) = ( {V}_{d c} ) ( 1 - {e}^{- α 2 t} cos ( {ω}_{d 2} t ) - \frac{α 2}{{ω}_{d 2}} {e}^{- α 2 t} sin ( {ω}_{d 2} t ) ) \qquad ( 4 )$$

Where,

$$α 1 = \frac{{R}_{r o n}}{2 {L}_{r o n}} and α2 = \frac{{R}_{roff}}{2 {L}_{roff}}$$

are attenuation constants; ω_{d1}=\sqrt{ωᵣ₁²−α1²} and ω_{d2}=\sqrt{ωᵣ₂²−α2²} are natural frequencies.

In some embodiments, for a WBG power semiconductor device operating at a particular switching frequency (fₛ), the resonant inductors Lᵣₒₙ and L_{roff} may be tuned such that the resonant frequencies of the crosstalk suppressing circuit are in a range of 0.1-2% of switching period Tₛ=1/fₛ.

FIG. 4 shows waveforms of the control signal G, switching states of SW1 and SW2, the gate-source voltage V_{gs} of the WBG power semiconductor device Q1, and the gate current i_{g}. As shown, the gate driving circuit can generate a bipolar gate-source voltage V_{gs} with a stable positive voltage V_{dc} and an adjustable negative voltage −Vₑ from a unipolar auxiliary source V_{dc} for a chosen wide band gap device.

For instance, only a +5 V unipolar voltage source is required to generate a Vgs with amplitude of +5/−3 V for a GaN device; and only a +15V unipolar voltage source is required to generate a V_{gs} with amplitude of of +15/−4V for a SiC device.

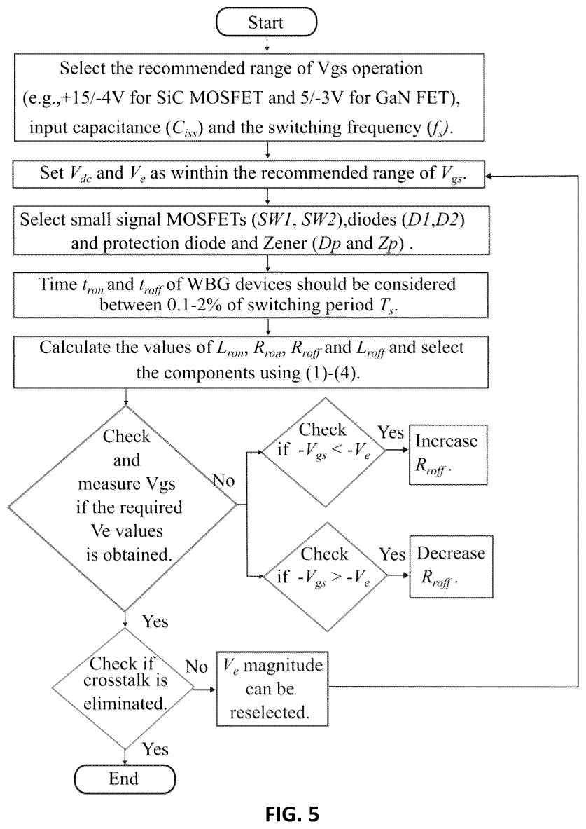

FIG. 5 shows the flow chart of key design steps for the gate driving circuit, starting with the selection of WBG power semiconductor device, switching devices and diodes, followed by calculations based on all the design equations (1)-(4) and crosstalk suppression check.

Table 1 shows a summary table of exemplary parameters of a gate driving circuit for driving a WBG SiC device having an input capacitance Cᵢₛₛ of 3863 pF operating at a switching frequency of 50 kHz with a unipolar DC voltage source of 15 V amplitude. Preferably, the resonant inductor Lᵣₒₙ has an inductance of 100 nH; the resonant inductor L_{roff} has an inductance of 300 nH; the resistor Rᵣₒₙ has a resistance of 1 Ω; and the resistor R_{roff} has a resistance of 3 Ω.

TABLE 1
Exemplary parameters of a gate driving circuit

| Parameters | Values | |
|---|---|---|
| V_{dc} | 15 | V |
| Cᵢₛₛ | 3863 | pF |
| Lᵣₒₙ | 100 | nH |
| L_{roff} | 300 | nH |
| Rₒₙ | 1 | Ω |
| R_{off} | 3 | Ω |
| f_{sw} | 50 | kHz |

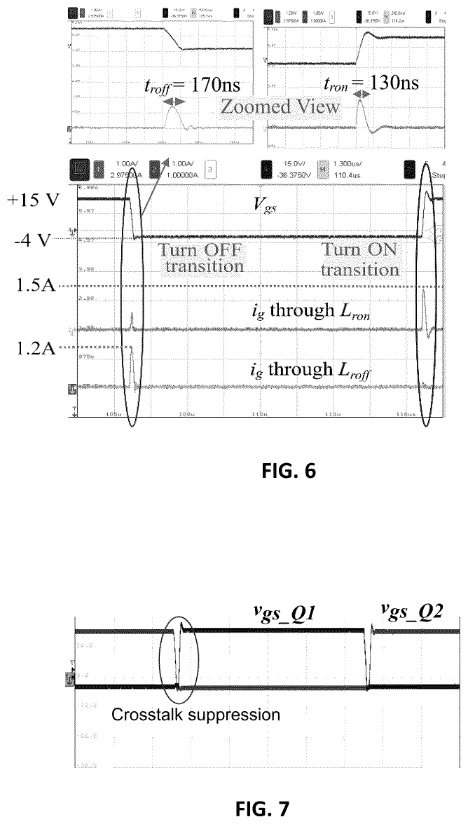

The experimental results in FIG. 6 show that the achieved turn-on transition period tᵣₒₙ and the turn-off transition period t_{roff} are 130 ns and 170 ns, respectively. With the use of the gate drive circuit 100, the input capacitance Cᵢₛₛ is charged and discharged sinusoidally based on the series resonance principle in each switching transition. Moreover, the utilization of two different inductors Lᵣₒₙ, L_{roff} offers distinct dv/dt control during turn-on and turn-off transitions of WBG power semiconductor devices operating at high switching frequencies and allows energy recycling between Lᵣₒₙ, L_{roff} and Cᵢₛₛ during each switching transitions.

Therefore, V_{gs} of WBG power semiconductor device is stabilized after each switching transition. Moreover, the provided gate driving circuit is more compact and has a low bill of materials (BOM) cost. It consumes lesser power and produces negligible harmonics, thus has less electromagnetic interference (EMI) issues.

The experimental results in FIG. 7 show the V_{gs} of two WBG power semiconductor devices Q1, Q2 in one leg configuration of a half bridge converter driven by the gate driver circuit where crosstalk is entirely suppressed.

Preferably, referring to FIG. 2, the semiconductor switching device SW1 is a p-channel MOSFET having a source being the high voltage terminal of the semiconductor switching device SW1; a drain being the low voltage terminal of the semiconductor switching device SW1; and a gate being the control terminal of the semiconductor switching device SW1. The semiconductor switching device SW2 is a n-channel MOSFET having a drain being the high voltage terminal of the semiconductor switching device SW2; a source being the low voltage terminal of the semiconductor switching device SW2; and a gate being the control terminal of the semiconductor switching device SW2.

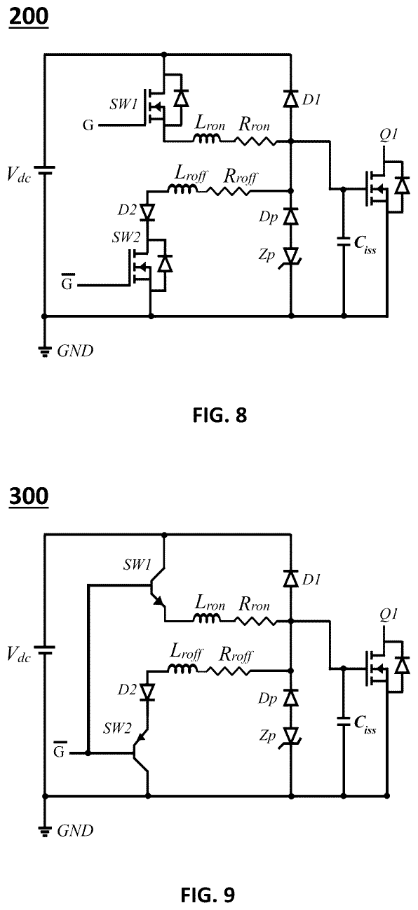

FIG. 8 shows a circuit diagram of a gate driving circuit 200 according to another embodiment of the present invention. The gate driving circuit 200 is similar to the gate driving circuit 100 except that the semiconductor switching device SW1 is a n-channel MOSFET having a drain being the high voltage terminal of the semiconductor switching device SW1; a source being the low voltage terminal of the semiconductor switching device SW1; and a gate being the control terminal of the semiconductor switching device SW1.

FIG. 9 shows a circuit diagram of a gate driving circuit 300 according to another embodiment of the present invention. The gate driving circuit 300 is similar to the gate driving circuit 100 except that the semiconductor switching device SW1 is a npn bipolar junction transistor having a collector being the high voltage terminal of the semiconductor switching device SW1; an emitter being the low voltage terminal of the semiconductor switching device SW1; and a base being the control terminal of the semiconductor switching device SW1. And the semiconductor switching device SW2 is a pnp bipolar junction transistor having an emitter being the high voltage terminal of the semiconductor switching device SW2; a collector being the low voltage terminal of the semiconductor switching device SW2; and a base being the control terminal of the semiconductor switching device SW2.

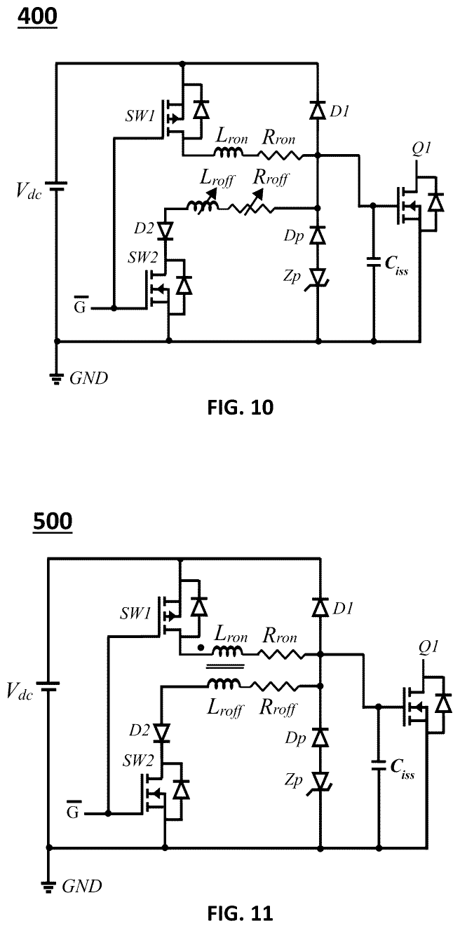

FIG. 10 shows a circuit diagram of a gate driving circuit 400 according to another embodiment of the present invention. The gate driving circuit 400 is similar to the gate driving circuit 100 except that the resonant inductor L_{roff} is a variable inductor and the resistor R_{roff} is a variable resistor. With the variable resonant inductor L_{roff} and resistor R_{roff}, the negative gate to source voltage −Vₑ and the turn-off transition period can be fine-tuned in practical implementations.

FIG. 11 shows a circuit diagram of a gate driving circuit 500 according to another embodiment of the present invention. The gate driving circuit 500 is similar to the gate driving circuit 100 except that the resonant inductor Lᵣₒₙ and the resonant inductor L_{roff} are coupled inductor with galvanic isolation to save the component count.

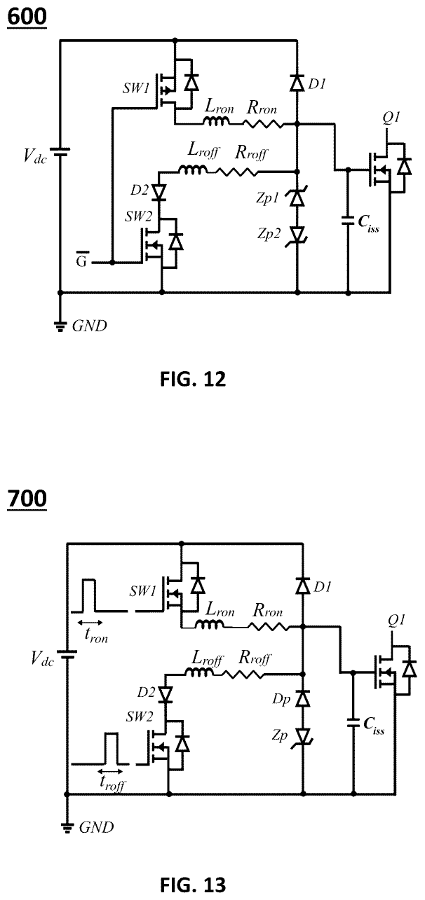

FIG. 12 shows a circuit diagram of a gate driving circuit 600 according to another embodiment of the present invention. The gate driving circuit 600 is similar to the gate driving circuit 100 except that the protection circuit may include a first Zener diode Zp1 and a second Zener diode Zp2 connected back-to-back with the first Zener diode Zp1. More specifically, the first Zener diode Zp1 has a cathode connected to the gate terminal of the WBG power semiconductor device Q1; the second Zener diode Zp2 has an anode connected to the anode of the first Zener diode Zp1 and a cathode connected to the source terminal of the WBG power semiconductor device Q1.

FIG. 13 shows a circuit diagram of a gate driving circuit 700 according to another embodiment of the present invention. The gate driving circuit 700 is similar to the gate driving circuit 100 except that the semiconductor switching devices SW1 and SW2 are driven by pulsed signals for further reducing the driver power consumption.

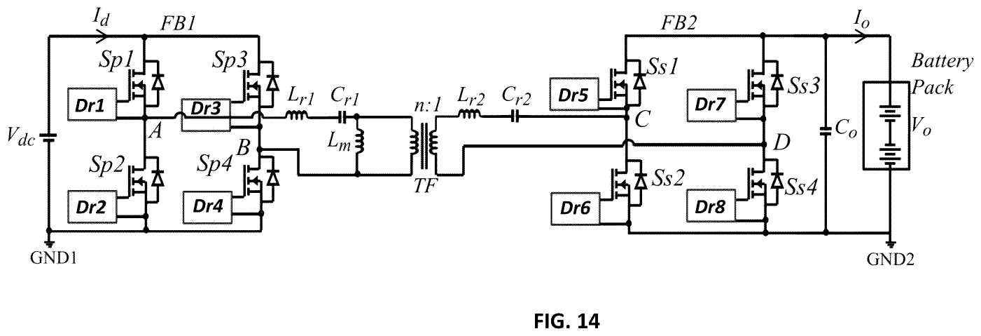

FIG. 14 shows a circuit diagram of a CLLC resonant converter-based battery energy storage system constructed with the gate driving circuits according to the embodiments of the present invention. As shown, the CLLC resonant converter-based battery energy storage system comprises one or more gate driving circuits Dr1-Dr8 configured for driving one or more wide band gap power devices Sp1-Sp4 and Ss1-Ss4, respectively.

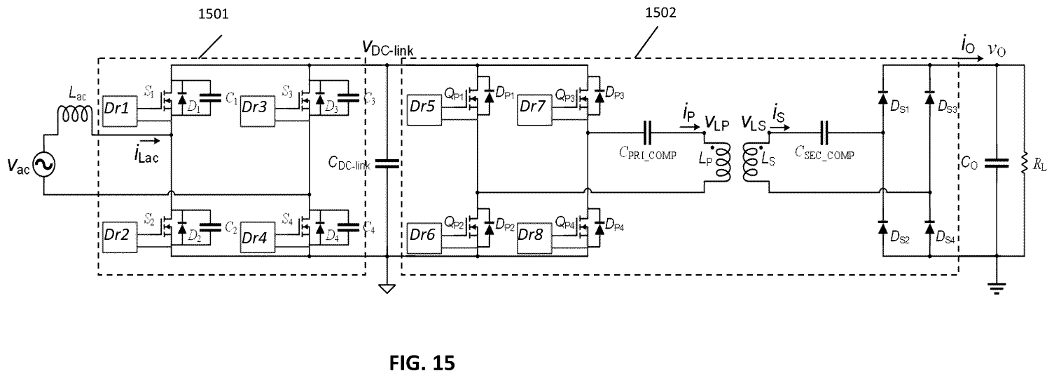

FIG. 15 shows a circuit diagram of a wireless power transfer system with an AC/DC hard-switched converter 1501 and a DC/DC hard-switched converter 1502, both converters are constructed with the gate driving circuits according to the embodiments of the present invention. As shown, the AC/DC hard-switched converter 1501 comprises gate driving circuits Dr1-Dr4 configured for driving wide bandgap power devices S₁-S₄, respectively; and the DC/DC hard-switched converter 1502 comprises gate driving circuits Dr5-Dr8 configured for driving wide bandgap power devices Qₚ₁-Qₚ₄, respectively.

While the present disclosure has been described and illustrated with reference to specific embodiments thereof, these descriptions and illustrations are not limited. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. Modifications may be made to adapt a particular situation, material, composition of matter, method, or process to the objective and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limited.

What is claimed is:

1. A gate driving circuit for driving a wide bandgap power device, comprising:
a DC voltage source;
a first semiconductor switching device having a high voltage terminal connected to a positive terminal of the DC voltage source and a control terminal connected to a controller output;
a second semiconductor switching device having a low voltage terminal connected to a negative terminal of the DC voltage source and a control terminal connected to a controller output; and
a crosstalk suppressing circuit including:
a first resonant inductor having a first end connected to a low voltage terminal of the first semiconductor switching device;
a first resistor having a first end connected to a second end of the first resonant inductor and a second end connected to a gate of the WBG power semiconductor device;
a first diode having an anode terminal connected to the gate of the WBG power semiconductor device and a cathode terminal connected to a positive terminal of the DC voltage source;
a second diode having a cathode connected to a high voltage terminal of the second semiconductor switching device;
a second resonant inductor having a first end connected to an anode of the second diode; and
a second resistor having a first end connected to a second end of the second resonant inductor and a second end connected to a gate of the WBG power semiconductor device; and
wherein the first resonant inductor and the first resistor are configured to form a path for charging an input capacitance of the WBG power semiconductor device up to the DC voltage source when a logic high control signal is generated from the controller output and applied to the gate terminal of first and second semiconductor switches; and
wherein the first diode is configured to clamp a gate-to-source voltage of the WBG power semiconductor device to the DC voltage source to serve as a protection; and
wherein the second diode, the second resonant inductor, and the second resistor are configured to form a path for discharging the input capacitance of WBG power semiconductor device, and to provide an adjustable negative gate-source turnoff voltage to the WBG power semiconductor device when a logic low control signal is generated from the controller output and applied to the gate terminal of first and second semiconductor switches.

2. The gate driving circuit according to claim 1, wherein
the first semiconductor switching device is a p-channel MOSFET having a source being the high voltage terminal of the first semiconductor switching device; a drain being the low voltage terminal of the first semiconductor switching device; and a gate being the control terminal of the first semiconductor switching device; and
the second semiconductor switching device is a n-channel MOSFET having a drain being the high voltage terminal of the second semiconductor switching device; a source being the low voltage terminal of the second semiconductor switching device; and a gate being the control terminal of the second semiconductor switching device.

3. The gate driving circuit according to claim 1, wherein
the first semiconductor switching device is a n-channel MOSFET having a drain being the high voltage terminal of the first semiconductor switching device; a source being the low voltage terminal of the first semiconductor switching device; and a gate being the control terminal of the first semiconductor switching device; and
the second semiconductor switching device is a n-channel MOSFET having a drain being the high voltage terminal of the second semiconductor switching device; a source being the low voltage terminal of the second semiconductor switching device; and a gate being the control terminal of the second semiconductor switching device.

4. The gate driving circuit according to claim 1, wherein
the first semiconductor switching device is a npn bipolar junction transistor having a collector being the high voltage terminal of the first semiconductor switching device; an emitter being the low voltage terminal of the first semiconductor switching device; and a base being the control terminal of the first semiconductor switching device; and
the second semiconductor switching device is a pop bipolar junction transistor having an emitter being the high voltage terminal of the second semiconductor switching device; a collector being the low voltage terminal of the second semiconductor switching device; and a base being the control terminal of the second semiconductor switching device.

5. The gate driving circuit according to claim 1, wherein the second resonant inductor is a variable inductor, and the second resistor is a variable resistor.

6. The gate driving circuit according to claim 1, wherein the first and second resonant inductors are coupled inductors.

7. The gate driving circuit according to claim 1, further comprising a protection circuit across the gate and source terminals of the WBG power semiconductor device.

8. The gate driving circuit according to claim 1, wherein the protection circuit includes a diode having a cathode connected to the gate of the WBG power semiconductor device; and a Zener diode having an anode connected to an anode of the diode and a cathode connected to the source terminal of the WBG power semiconductor device.

9. The gate driving circuit according to claim 1, wherein the protection circuit includes a first Zener diode having a cathode connected to the gate of the WBG power semiconductor device; and a second Zener diode having an anode connected to an anode of the first Zener diode and a cathode connected to the source terminal of the WBG power semiconductor device.

10. A CLLC resonant converter-based battery energy storage system comprising one or more gate driving circuits of claim 1 configured for driving one or more wide band gap power devices respectively.

11. The CLLC resonant converter-based battery energy storage system according to claim 9, wherein
the first semiconductor switching device is a p-channel MOSFET having a source being the high voltage terminal of the first semiconductor switching device; a drain being the low voltage terminal of the first semiconductor switching device; and a gate being the control terminal of the first semiconductor switching device; and
the second semiconductor switching device is a n-channel MOSFET having a drain being the high voltage terminal of the second semiconductor switching device; a source being the low voltage terminal of the second semiconductor switching device; and a gate being the control terminal of the second semiconductor switching device.

12. The CLLC resonant converter-based battery energy storage system according to claim 9, wherein the second resonant inductor is a variable inductor; and the second resistor is a variable resistor.

13. The CLLC resonant converter-based battery energy storage system according to claim 9, wherein the protection circuit includes a diode having a cathode connected to the gate of the WBG power semiconductor device; and a Zener diode having an anode connected to an anode of the diode and a cathode connected to the source terminal of the WBG power semiconductor device.

14. The CLLC resonant converter-based battery energy storage system according to claim 9, wherein the protection circuit includes a first Zener diode having a cathode connected to the gate of the WBG power semiconductor device; and a second Zener diode having an anode connected to an anode of the first Zener diode and a cathode connected to the source terminal of the WBG power semiconductor device.

15. A wireless power transfer system having an AC/DC hard-switched converter and a DC/DC hard-switched converter, each of the AC/DC hard-switched converter and the DC/DC hard-switched converter comprising one or more gate driving circuits of claim 1 configured for driving one or more wide band gap power devices respectively.

16. The wireless power transfer system according to claim 15, wherein
the first semiconductor switching device is a p-channel MOSFET having a source being the high voltage terminal of the first semiconductor switching device; a drain being the low voltage terminal of the first semiconductor switching device; and a gate being the control terminal of the first semiconductor switching device; and
the second semiconductor switching device is a n-channel MOSFET having a drain being the high voltage terminal of the second semiconductor switching device; a source being the low voltage terminal of the second semiconductor switching device; and a gate being the control terminal of the second semiconductor switching device.

17. The wireless power transfer system according to claim 15, wherein the second resonant inductor is a variable inductor, and the second resistor is a variable resistor.

18. The wireless power transfer system according to claim 15, wherein the first and second resonant inductors are coupled inductors.

19. The wireless power transfer system according to claim 15, wherein the protection circuit includes a diode having a cathode connected to the gate of the WBG power semiconductor device; and a Zener diode having an anode connected to an anode of the diode and a cathode connected to the source terminal of the WBG power semiconductor device.

20. The wireless power transfer system according to claim 15, wherein the protection circuit includes a first Zener diode having a cathode connected to the gate of the WBG power semiconductor device; and a second Zener diode having an anode connected to an anode of the first Zener diode and a cathode connected to the source terminal of the WBG power semiconductor device.
